(19) United States
(12) Patent Application Publication
(10) Pub. No.: US 2026/0369445 A1
(43) Pub. Date: Nov. 19, 2026

(54) COMPOSITE ARMOR DYNAMIC CABLE WITH SMALL MINIMUM BEND RADIUS

(71) Applicant: Schlumberger Technology Corporation, Sugar Land, TX (US)

(72) Inventors: Pierre CLERY, Abbeville (FR); Pierre-Yves CORRE, Abbeville (FR); Oguzhan BAYIR, Abbeville (FR)

(21) Appl. No.: 19/139,558

(22) PCT Filed: Dec. 12, 2023
(86) PCT No.: PCT/US2023/083493

§ 371 Date: Jun. 16, 2025

Related U.S. Application Data
(60) Provisional application No. 63/476,647, filed on Dec. 22, 2022.

(51) Int. Cl. H01B 7/18; D07B 1/16; H01B 11/22

(52) U.S. Cl. CPC H01B 7/1805; D07B 1/16; H01B 11/22; D07B 2201/2088; D07B 2401/2065; D07B 2501/2076

(57) ABSTRACT

A cable that has a core. The core has a conductor for transmitting at least one of electrical and optical signals. Armor is disposed around the core. The armor includes at least in part a composite material layer. The composite material layer has fibers wound around the core. The fibers are at least partially a non-metallic material with a matrix binding the fibers.

### CROSS-REFERENCE TO RELATED APPLICATION

This application claims priority to U.S. Provisional Patent Application No. 63/476647, filed on Dec. 22, 2022, which is incorporated by reference herein.

### BACKGROUND OF THE DISCLOSURE

Offshore wind is a promising source of renewable energy because offshore wind is more intense and uniform than onshore wind. Most wind farms currently are being developed in prime shallow-water locations with a depth of up to 50 to 60 meters. However, up to 80% of the world's best wind resources can be found in areas where the water is much deeper. Nonetheless, offshore wind potential generally remains untapped.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a sectional axial view of at least a portion of an example implementation of apparatus according to one or more aspects of the present disclosure.

FIG. 2 is a schematic side view of a portion of an example implementation of apparatus according to one or more aspects of the present disclosure.

FIG. 3 is a schematic side view of a portion of an example implementation of apparatus according to one or more aspects of the present disclosure.

FIG. 4 is a schematic side view of a portion of an example implementation of apparatus according to one or more aspects of the present disclosure.

### DETAILED DESCRIPTION

It is to be understood that the following disclosure provides many different examples for implementing different features of various implementations. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity and does not in itself dictate a relationship between the various embodiments and/or configurations discussed. Moreover, the formation of a first feature over or on a second feature in the description that follows may include implementations in which the first and second features are formed in direct contact and implementations in which additional features may be formed interposing the first and second features, such that the first and second features may not be in direct contact.

Instead of the shallow-water wind farms described above, floating wind turbines may be utilized to harness wind power in deeper waters further offshore, where such turbines are mounted on floating structures that are tethered in position. Floating wind turbines face technical challenges different from both onshore wind turbines and floating oil and gas platforms. Similar floating structures, with the same technical challenges, can be used for supporting the floating solar panels.

Like bottom-fixed offshore wind farms, exporting energy from floating wind farms and solar panels to onshore and/or other offshore facilities requires high-capacity subsea cables, known in the art as dynamic cables. While conventional subsea cables are installed or secured on the seabed, dynamic cables used for floating offshore wind power turbines and solar panels have floating components that enable them to move with subsea tidal currents. Dynamic cables are thus continuously subjected to tensile, bending, and twisting forces caused by movements of the floating structures, water depth, surface waves, and subsea currents. Therefore, dynamic cables frequently experience mechanical damage caused by the harsh dynamic subsea environment and need to be replaced. Accordingly, a lightweight, flexible, and high tensile strength dynamic capable for transmitting electrical power continues to be sought.

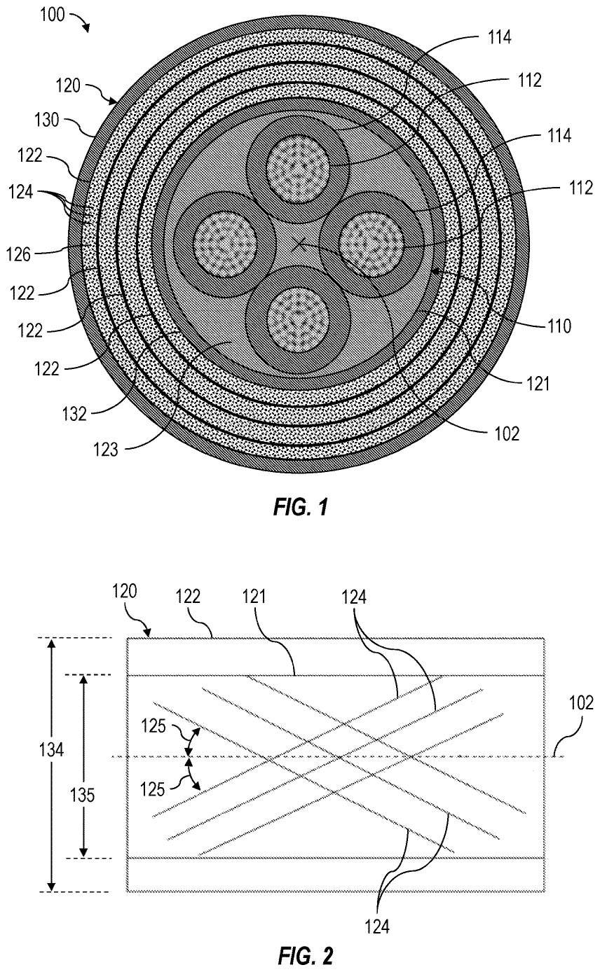

FIG. 1 is a sectional axial view of an example cable 100 according to one or more aspects of the present disclosure. The cable 100 may be used in a subsea (e.g., marine) environment to transmit electrical power and/or data (i.e., information) between two offshore facilities, vessels, and/or other objects. Such offshore facilities, vessels, and/or other objects may include, for example, offshore (e.g., floating) oil and gas well drilling and production rigs, offshore (e.g., floating or sea floor) production facilities, offshore (e.g., floating) windmills, offshore (e.g., surface and/or subsurface) vessels, and offshore (e.g., sea floor) wellheads.

The cable 100 may comprise a core 110 having one or more conductors 112 for transmitting electrical power and/or data. The conductors 112 may be or comprise electrical conductors formed of an electrically conductive metal (e.g., copper, aluminum, etc.). The electrical conductors may be configured for transmitting electrical power and/or data in the form of electrical signals. The conductors 112 may also include optical conductors (e.g., fiber optic cables) for transmitting data in the form of optical signals. Each set of conductors 112 may be covered by a corresponding liner (or cover) 114.

The cable 100 may further comprise an armor (or reinforcement layer) 120 disposed around the core 110. The armor 120 may define a passage (or bore) 121 extending axially therethrough. The passage 121 may be configured to receive the core 110 such that the core 110 and the armor 120 extend in a concentric manner along a central axis 102 of the cable 100. The passage 121 between the core 110 and the armor 120 may be or comprise empty space. However, the passage 121 between the core 110 and the armor 120 may be filled with a matrix 123 binding the conductors 112. The matrix 123 may be or comprise, for example, at least one of rubber, a thermosetting polymer, a thermoplastic, a thermoplastic elastomer, and an elastomeric material.

The armor 120 may comprise at least one composite material layer 122 having fibers 124 within a matrix 126 binding the fibers 124. The fibers 124 may be or comprise non-metallic fiber material, such as one or more of carbon fibers, linen fibers, nylon fibers, Kevlar fibers, and yarn fibers. The matrix 126 may be or comprises at least one of a thermosetting polymer, a thermoplastic, a thermoplastic elastomer, and an elastomeric material. The thermosetting polymer may be or comprises at least one of an epoxy and a vinyl ester, and the thermoplastic may be or comprises a recyclable resin. The matrix 126 may comprise a material having a low Young's modulus, such as ranging between about 6 mega pascals (MPa) (e.g., rubber matrix) and 800 MPa, and/or a low shear modulus, such as ranging between about 1 MPa and 200 MPa. The matrix 126 may also comprise a hardener (or rigidizer). The matrix 126 may instead comprise a plasticizer decreasing the shear modulus and/or Young's modulus of the matrix 126. An example plasticizer may be or comprise polyvinyl chloride (PVC). The percentage (%) ratio (or proportion) of fibers 124 to matrix 126 of the composite material layer 122 may range between about 50% and 70%. The resulting material density of the composite material layer 122 may range between about 1.2 grams per cubic centimeter (g/cm³) and 2.0 g/cm³.

FIG. 2 is a schematic side sectional view of a segment of an example implementation of the armor 120 of the cable 100 shown in FIG. 1. Accordingly, the following description refers to FIGS. 1 and 2, collectively.

The fibers 124 of the composite material layer 122 may be wound around the core. The fibers 124 of the composite material layer 122 may be wound around the core 110 at an angle 125 ranging between about 54 degrees and 56 degrees with respect to the central axis 102 of the cable 100. For example, the fibers 124 of the composite material layer 122 may be wound around the core 110 at an angle 125 of about 54 degrees, 55 degrees, or 56 degrees with respect to the central axis 102 of the cable 100. The fibers 124 of the composite material layer 122 may be wound around the core 110 in a helical and/or braided manner. The composite material layer 122 may have a thickness ranging between about 2.70 millimeters (mm) and 3.70 mm. For example, the composite material layer 122 may have a thickness of about 3.00 mm, 3.20 mm, or 3.40 mm.

The armor 120 of the cable 100 may comprise a plurality of composite material layers 122, each having the same or similar specifications as described herein. Thus, the composite material layer 122 described herein may be an instance of a plurality of composite material layers 122, each having the same or similar specifications as described herein. As shown in FIG. 1, the armor 120 of the cable 100 may comprise four composite material layers 122. However, the armor 120 of the cable 100 according to one or more aspects of the present disclosure may instead comprise two composite material layers 122, three composite material layers 122, five composite material layers 122, or six or more composite material layers 122, each having the same or similar specifications as described herein. Each composite material layer 122 may be bound to an adjacent composite material layer 122. For example, during manufacturing of the cable 100 or just the armor 120, as each subsequent composite material layer 122 is formed, the material forming the matrix 126 of a subsequently formed composite material layer 122 may bind (or fuse) with the material forming the matrix 126 of a previously formed composite material layer 122.

The armor 120 of the cable 100 may further comprise an outer liner (or cover) 130 covering the composite material layers 122. The outer liner 130 may have a thickness ranging between about 2.00 mm and 3.00 mm. For example, the outer liner 130 may have a thickness of about 2.00 mm, 2.50 mm, or 3.00 mm. The material forming the outer liner 130 may be or comprise rubber. The armor 120 of the cable 100 may also comprise an inner liner (or cover) 132 covered by the composite material layers 122 and covering the core 110. The inner liner 132 may have a thickness ranging between about 2.00 mm and 3.00 mm. For example, inner liner 132 may have a thickness of about 2.00 mm, 2.50 mm, or 3.00 mm. The material forming the inner liner 132 may be or comprise rubber. The armor 120 (and the cable 100) may comprise an outer diameter 134 and an inner diameter 135 defining the passage 121 configured to accommodate (or receive) the core 110.

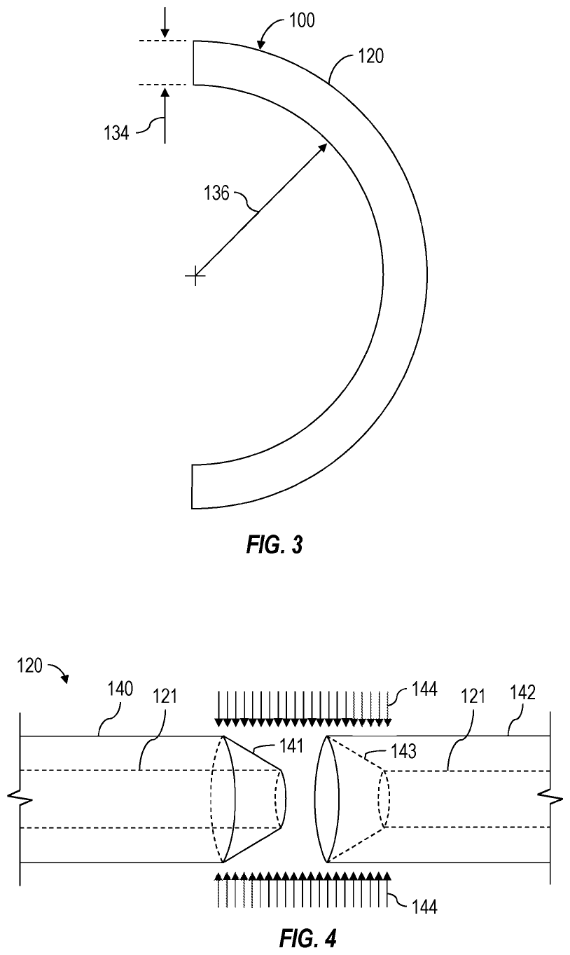

FIG. 3 is a schematic side view of a segment of an example implementation of the cable 100 shown in FIGS. 1 and 2. Accordingly, the following description refers to FIGS. 1-3, collectively.

The armor 120 of the cable 100, including the composite material layers 122, as described herein, may facilitate both a relatively high resistance to axial strain caused by axial tension applied to the cable 100 and a relatively high flexibility allowing the cable 100 to bend without damaging one or more portions (e.g., the core 110 and/or the armor 120) of the cable 100. For example, the cable 100 may comprise a minimum bend radius 136 ranging between about 3.0 and 5.0 times the outer diameter 134 of the cable 100. In an example implementation of the cable 100, the minimum bend radius 136 may be about 3.0, 3.5, 4.0, 4.5, or 5.0 times the outer diameter 134 of the cable 100. To increase resistance to axial strain of the cable 100, the fibers 124 of the composite material layers 122 may be wound at an angle 125 that is smaller than 54 degrees. For example, to increase resistance to axial strain of the cable 100, the fibers 124 of the composite material layers 122 may be wound at an angle 125 ranging between abut 50 and 54 degrees. However, to decrease resistance to axial strain of the cable 100, the fibers 124 of the composite material layers 122 may be wound at an angle 125 that is greater than 56 degrees. For example, to decrease resistance to axial strain and increase of the cable 100, the fibers 124 of the composite material layers 122 may be wound at an angle 125 ranging between abut 56 and 60 degrees.

The armor 120 of the cable 100, including the composite material layers 122, as described herein, may facilitate neutral buoyancy of the cable 100 within a natural body of water, such that the cable 100 moves with the water within the natural body of water. Such neutrally buoyant cable 100 may impart little or no downward tension on an upper (e.g., surface) offshore facility, vessel, and/or object, and little or no downward tension on a lower (e.g., seabed) offshore facility, vessel, and/or object.

In an example implementation of the cable 100 according to one or more aspects of the present disclosure, the core 110 and the armor 120 may be manufactured separately and then assembled (or combined) right before the cable 100 is connected to an offshore facility, vessel, and/or other object and deployed (or installed) within a body of water. For example, the core 110 and the armor 120 may be manufactured onshore separately and continuously by one or more machines, then transported to and assembled on an offshore facility or vessel, and then deployed within a body of water. The core 110 and the armor 120 may instead be manufactured offshore on an offshore facility or vessel separately and continuously by one or more machines, then assembled on the offshore facility or vessel, and then deployed within a body of water.

However, instead of manufacturing the entire length of the armor 120 as a single segment (or piece), the armor 120 may be manufactured onshore or offshore in several segments and then connected together onshore or offshore to form a single segment having an intended total length. The core 110 and the connected single segment of armor 120 may then be assembled on an offshore facility or vessel right before the cable 100 is connected to an offshore facility, vessel, and/or other object, and then deployed within a body of water.

FIG. 4 is a schematic side view of portions of two segments (or pieces) 140, 142 of example implementations of armor 120 of the cable 100 shown in FIGS. 1-3. Accordingly, the following description refers to FIGS. 1-4, collectively.

Connecting the two segments 140, 142 of the armor 120 may include applying heat 144 to adjacent ends 141, 143 of the segments 140, 142, respectively, to cause the material forming the matrix 126 of the composite material layers 122 to melt. The adjacent ends 141, 143 of the segments 140, 142 may then be fused (i.e., caused to contact such that the melted portions of the adjacent ends 141, 143 of the segments 140, 142 merge and then permitted to cool such that the adjacent ends 141, 143 bind), thereby connecting the adjacent ends 141, 143 of the segments 140, 142. The adjacent ends 141, 143 of the segments 140, 142 may be cut or otherwise formed so as to comprise complimentary outer and inner conical surfaces, thereby increasing surface areas of the adjacent ends 141, 143 of the segments 140, 142 that are melted and then fused. Connecting a plurality of segments 140, 142 of armor 120 to form a single segment of armor 120 may permit a plurality of segments 140, 142 of armor 120, each having different mechanical (or physical) properties (e.g., buoyancy, resistance to axial strain, flexibility, etc.), to be incorporated into the cable 100. Such manner of forming the armor 120 may be used, for example, when a cable 100 having different (or changing) mechanical properties is required for an offshore job. Such manner of forming the armor 120 may also or instead be used, for example, to match operational parameters (or behavior) of the cable 100 with an offshore (e.g., subsea) environment in which the cable 100 is installed. Thus, connecting two or more segments 140, 142 of armor 120 may permit the cable 100 to be mechanically adapted to different offshore applications and/or environment.

The core 110 and/or the armor 120 may be manufactured continuously in lengths ranging between, for example, about 100 meters and 2000 meters. Assembly of the separately formed core 110 and armor 120 may include inserting (or sliding) the core 110 within the axial passage 121 of the armor 120. Thus, the core 110 may comprise an outside diameter that is smaller than the inside diameter 135 of the armor 120.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions, and alterations herein without departing from the scope of the present disclosure.

What is claimed is:

1. A cable comprising:
a core comprising a conductor for transmitting at least one of electrical and optical signals; and
an armor disposed around the core, wherein the armor comprises a composite material layer, and wherein the composite material layer comprises:
fibers wound around the core at an angle of about 55 degrees with respect to a central axis of the cable, wherein the fibers comprise a non-metallic material; and
a matrix binding the fibers.

2. The cable of example 1 wherein the matrix comprises a low Young's modulus.

3. The cable of example 1 wherein the matrix comprises Young's modulus ranging between about 6 mega pascals (MPa) and 800 MPa.

4. The cable of example 1 wherein the fibers are or comprise at least one of carbon, linen, nylon, and yarn.

5. The cable of example 1 wherein the matrix is or comprises at least one of a thermosetting polymer, a thermoplastic, a thermoplastic elastomer, and an elastomeric material.

6. The cable of example 5 wherein the thermosetting polymer is or comprises at least one of an epoxy and a vinyl ester, and wherein the thermoplastic is or comprises a recyclable resin.

7. The cable of example 5 wherein the matrix comprises a plasticizer for lowering shear modulus of the matrix.

8. The cable of example 1 wherein:
the cable comprises an outer diameter;
the cable comprises a minimum bend radius; and
the minimum bend radius is between about four to five times the outer diameter.

9. The cable of example 1 wherein the armor further comprises at least one of:
an inner liner covered by the composite material layer and covering the core, wherein the inner liner comprises rubber; and
an outer liner covering composite material layer, wherein the outer liner comprises rubber.

10. The cable of example 9 wherein the inner liner has a thickness of about 2.50 millimeters.

11. The cable of example 9 wherein the outer liner has a thickness of about 2.50 millimeters.

12. The cable of example 1 wherein the composite material layer has a thickness of about 3.20 millimeters.

13. The cable of example 1 wherein:
the composite material layer is a first composite material layer;
the fibers are first fibers;
the matrix is a first matrix; and
the armor further comprises a second composite material layer comprising:
second fibers wound around the core at an angle of about 55 degrees with respect to the central axis of the cable, wherein the second fibers comprise a non-metallic material; and
a second matrix binding the second fibers.

14. The cable of example 1 wherein:
the composite material layer is an instance of a plurality of composite material layers each comprising:
fibers wound around the core at an angle of about 55 degrees with respect to a central axis of the cable, wherein the fibers comprise a non-metallic material; and
a matrix binding the fibers.

15. The cable of example 14 wherein each of the composite material layers has a thickness of about 3.20 millimeters.

16. The cable of example 14 wherein the cable comprises four composite material layers.

17. The cable of example 1 wherein the core comprises electrical conductors, and wherein the cable comprises neutral buoyancy within a natural body of water.
